(19) United States
(12) Patent Application Publication
(10) Pub. No.: US 2005/0022234 A1
(43) Pub. Date: Jan. 27, 2005

(54) Method and apparatus for personalizing rating limits in a parental control system

(76) Inventors: James Alan Strothman, Zionsville, IN (US); Carl C. Hu, Carmel, IN (US)

Correspondence Address: Joseph S Tripoli;Thomson Multimedia Licensing Inc, P O Box 5312, Princeton, NJ, 08543-5312, US

(21) Appl. No.: 10/502,499

(22) PCT Filed: Jan. 24, 2003
(86) PCT No.: PCT/US03/02104

Related U.S. Application Data
(60) Provisional application No. 60/352,762, filed on Jan. 29, 2002.

(51) Int. Cl. H04N 7/025; H04N 5/445; G06F 3/00; H04N 7/10

(52) U.S. Cl. 725/34; 725/35; 725/46

(57) ABSTRACT

A method and apparatus enables users to personalize the rating limits used for content blocking in parental control systems. According to an exemplary embodiment, an apparatus includes an interface for detecting a user input indicating the acceptability of a rating sample having a first rating from a first source. A processor generates a first transition point based on the user input and the first rating, and uses the first transition point to determine whether data from the first source is output or blocked.

### BACKGROUND OF THE INVENTION

1. Field of the Invention

The present invention generally relates to parental control systems, and more particularly, to a method and apparatus that enables users to personalize the rating limits used for content blocking in parental control systems.

2. Background Information

Television broadcasts and Internet transmissions often contain content, such as violence, indecent language, sexual situations, and the like that may be harmful to children. To address this issue, various parental control systems have been developed for blocking inappropriate content.

In the United States, a blocking system known as “V-Chip” has been employed for television content ratings. According to one version of this system, rating signals are encoded by the broadcaster within the vertical blanking interval (VBI) of the analog television signal. The rating signals are transmitted with the respective audio/video content and detected by the V-Chip system implemented in the receiver. The system decodes the rating signals, compares the decoded results to predetermined user rating settings, and then either blocks or allows output of the signal based on the comparison.

A system such as V-Chip utilizes two different rating systems: the TV Parental Guidelines, and the Motion Picture Association of America (MPAA) ratings. The TV Parental Guidelines include an age-based rating that suggests the age group for which a particular program is considered suitable for viewing. For example, the age-based ratings of the TV Parental Guidelines include:
TV-Y: Designed to be appropriate for all children, especially for ages 2-6.
TV-Y7: Designed for children age 7 and above.
TV-G: Most parents would find the program suitable for all ages.
TV-PG: Contains material that parents might find unsuitable for younger children.
TV-14: Contains some material that many parents would find inappropriate for children under 14.
TV-MA: Specifically designed to be viewed by adults and unsuitable for children under 17.

These age-based ratings may be combined with one or more letters indicating content with higher levels of violence (V), sexual situations (S), coarse or crude indecent language (L), suggestive dialogue (D) or fantasy violence (FV). For example, a program rated TV-PG that contains higher than usual levels of violence and sexual situations may be labeled TV-PG-V-S.

The MPAA ratings are also divided into age groups based on content (e.g., violence, indecent language, sexual situations, etc.). However, the MPM ratings differ from the TV Parental Guidelines and use the following different ratings:
G: All ages admitted.
PG: Some material may not be suitable for children.
PG-13: Some material may be inappropriate for children under 13
R: Under 17 requires accompanying parent or guardian.
NC-17: Requires all persons to be over the age of 17.
X: Restricted to adults.

With both of the aforementioned rating systems, the setting of rating limits is typically performed via user inputs responsive to an on-screen menu. For example, with the MPM rating system, a user may select the PG-13 rating indicating that all programs above this rating should be blocked, and all programs below this rating are deemed acceptable. Similarly, with the TV Parental Guidelines, a user also selects an age-based rating such as TV-14, but also determines whether to block certain types of content, wherein the content-based rating may be defined differently for the various age-based ratings. It is also conceivable that ratings systems other than the MPAA system and the TV Parental Guidelines may be used in the future.

The use of different rating systems presents certain problems for consumer users. For example, it is often difficult for users to compare or translate one rating system to another since different rating systems use different ratings, different numbers of ratings, and different rating definitions. Moreover, the abstract rating definitions tend to be rather subjective. For example, one source may assign a given rating to a particular program, while another source may assign a different rating (i.e., higher or lower) to the same program. As a result, there is a risk that the rating limits selected by users may not achieve the desired effects. For example, programs that a parent would normally allow the household children to view may inadvertently be blocked, or programs that the parent would normally want to block may inadvertently be allowed.

Accordingly, there is a need for an improved parental control system which avoids the foregoing problems, and thereby allows a user to personalize the rating limits used for content blocking. The present invention addresses these and other issues.

### SUMMARY OF THE INVENTION

In accordance with an aspect of the present invention, a method for personalizing rating limits in a parental control system is disclosed. According to an exemplary embodiment, the method comprises enabling reproduction of a rating sample having a first rating from a first source, detecting a user input indicating the acceptability of the rating sample, generating a first transition point based on the user input and the first rating, and using the first transition point to determine whether data from the first source is output or blocked.

In accordance with another aspect of the present invention, an apparatus for personalizing rating limits in a parental control system is disclosed. According to an exemplary embodiment, the apparatus comprises interface means for detecting a user input indicating the acceptability of a rating sample having a first rating from a first source. The apparatus further comprises control means for generating a first transition point based on the user input and the first rating, and for using the first transition point to determine whether data from the first source is output or blocked.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a relevant portion of an exemplary apparatus suitable for implementing the present invention;

FIG. 2 is a flowchart illustrating exemplary steps for carrying out an embodiment of the present invention;

FIG. 3 is a diagram illustrating exemplary rating samples and user rating assignments according to the embodiment of FIG. 2;

FIG. 4 is a flowchart illustrating exemplary steps for carrying out another embodiment of the present invention; and

FIG. 5 is a diagram illustrating exemplary rating samples and user privileges according to the embodiment of FIG. 4.

The exemplifications set out herein illustrate preferred embodiments of the invention, and such exemplifications are not to be construed as limiting the scope of the invention in any manner.

### DESCRIPTION OF THE PREFERRED EMBODIMENTS

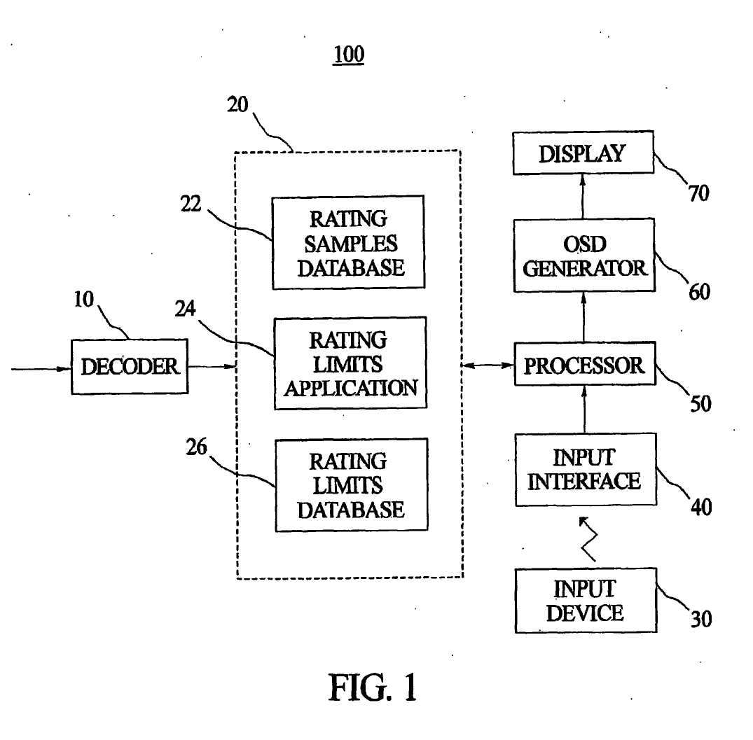

Referring now to the drawings, and more particularly to FIG. 1, a relevant portion 100 of an exemplary apparatus suitable for implementing the present invention is shown. For purposes of example and explanation, FIG. 1 represents a portion of a television signal receiver (e.g., television set, set-top box, etc.) having a parental control system and conventional components such as a tuner and demodulator are not shown. However, as will be explained later herein, principles of the present invention may also be applied to other apparatuses having a parental control system.

The exemplary apparatus portion 100 shown in FIG. 1 includes a decoder 10, a memory device 20, an input device 30, an input interface 40, a processor 50, an on-screen display (OSD) generator 60, and a display 70. Also shown in FIG. 1, memory device 20 includes a rating samples database 22, a rating limits application 24, and a rating limits database 26.

Decoder 10 is operative to receive and decode a signal comprising data for enabling personalization of rating limits according to principles of the present invention. The signal received by decoder 10 may for example be included as an auxiliary information component of a television signal (e.g., within the VBI and/or as one or more packets of digital data), and/or may be provided via a network such as the internet. Moreover, the received signal may comprise data such as electronic program guide (EPG) data and/or data representing up-to-date rating samples and corresponding ratings. As will be explained later herein, such rating samples may be stored in rating samples database 22 of memory device 20, and accessed upon request of a user.

Memory device 20 may be embodied as one or more volatile and/or non-volatile memories, such as random access memories (RAMs), read only memories (ROM), flash memories, programmable memories, or the like. Accordingly, rating samples database 22, rating limits application 24, and rating limits database 26 may be embodied on one or more integrated circuits (ICs).

Ratings samples database 22 is operative to store data comprising rating samples and corresponding rating data assigned by one or more different sources. That is, each rating sample includes at least one rating assigned by a given source, but may include a plurality of ratings assigned by a plurality of different sources. Such rating samples may include image (e.g., video, text, etc.) and/or audio content. As previously indicated herein, such rating samples may be provided to the apparatus from an external source (e.g., via television broadcast, internet, etc.), and may be periodically updated to ensure that up-to-date rating samples are utilized by a user when personalizing rating limits.

According to another exemplary embodiment, however, rating samples may be permanently stored within rating samples database 22 by the manufacturer, and therefore are not capable of being updated. Although the stored rating samples may become out-of-date with this embodiment, this may not be a serious drawback since certain apparatuses such as television sets and computers are often bought and installed once and not resold.

According to still another embodiment, rating samples database 22 may not be included within the apparatus itself. For example, rating samples database 22 may be stored within a remote server (not shown) which is periodically accessed to provide up-to-date rating samples and corresponding ratings, without sacrificing memory capacity within the apparatus. As another example, currently broadcast programs having recommended ratings embedded therein may be used as rating samples.

Rating limits application 24 comprises program code which is executed by processor 50 to enable a user to personalize rating limits according to principles of the present invention. As will be discussed later herein, data representative of these personalized rating limits is stored in rating limits database 26, and used by the apparatus during operation of its parental control system. Rating limits database 26 may for example be included within the apparatus itself, as shown in FIG. 1, or alternatively, may be stored within a remote server and periodically updated and/or accessed.

Input device 30 enables a user to provide inputs to the apparatus for personalizing rating limits according to principles of the present invention. Input device 30 may for example be embodied as a hand-held remote control, a keypad, a computer mouse, a microphone, a touch screen, or the like. Input interface 40 is operative to detect inputs from input device 30, and thereby enables processor 50 to receive input commands from input device 30. OSD generator 60 generates images for display on display 70 (e.g., television screen, monitor, etc.) under the control of processor 50. As will discussed later herein, processor 50 may cause images to be blocked from display 70 when the rating limits associated with the images exceed certain user defined rating limits.

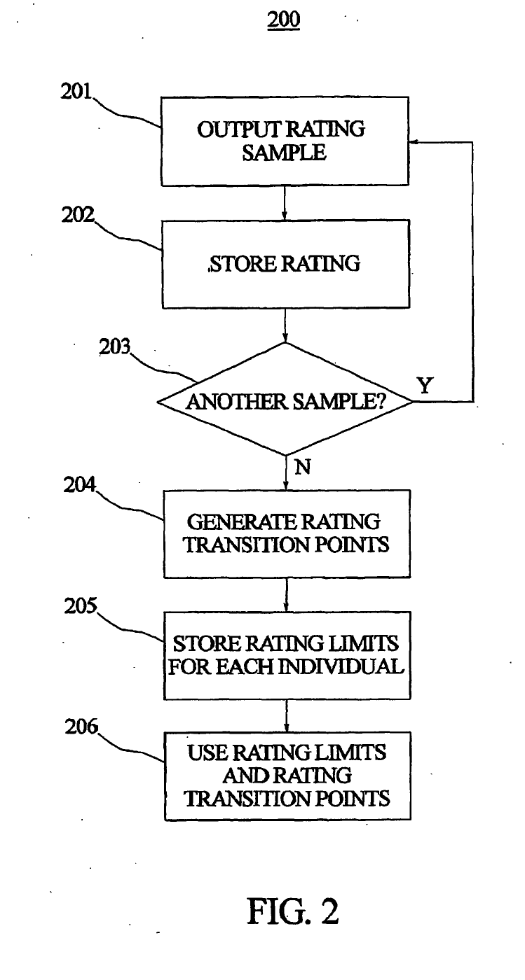

Referring to FIG. 2, a flowchart 200 illustrating exemplary steps for carrying out an embodiment of the present invention is shown. For purposes of example and explanation, the steps of FIG. 2 will be described with reference to the portion 100 of the apparatus shown in FIG. 1. Accordingly, the steps of FIG. 2 are merely exemplary and are not intended to limit the present invention in any manner.

At step 201, processor 50 executes rating limits application 24 and thereby causes a rating sample to be retrieved from rating samples database 22 and output for user evaluation. According to an exemplary embodiment, the rating sample comprises image data (e.g., video, still shot, text, etc.) and is output for display on display 70. However, as previously indicated herein, the rating sample may also comprise other data such as audio data.

At step 202, the user assigns a rating to the output rating sample, and processor 50 causes data representative of the assigned rating to be stored in rating limits database 26. According to an exemplary embodiment, the user assigns the rating level at step 202 via input device 30 and an on-screen menu (e.g., EPG) on display 70. For example, in the event the rating sample comprises a video segment, the user may be prompted by an on-screen menu to assign one of the MPAA ratings to the video segment. Similarly, the user may be prompted to assign a different type of rating to the segment, such as a TV Parental Guidelines rating or other type of rating. According to an exemplary embodiment, the number of rating levels that the user may assign to a sample at step 202 is less than the number of rating levels used by the one or more sources that assign a rating to the sample. This, however, is not a requirement. Accordingly, the number of rating levels that the user may assign to a sample may be greater than or equal to the number of rating levels used by the one or more sources that assign a rating to the sample.

After the assigned rating is stored at step 202, process flow advances to step 203 where the user has the option to rate another sample. In the event the user decides to rate another sample, process flow loops back to step 201 where processor 50 causes another rating sample to be retrieved from rating samples database 22 and output for user rating. In this manner, the user may evaluate and rate many different rating samples, as well as different types (e.g., image, audio) thereof. As will be discussed later herein, a greater degree of rating limit personalization is achieved as more samples are rated by the user.

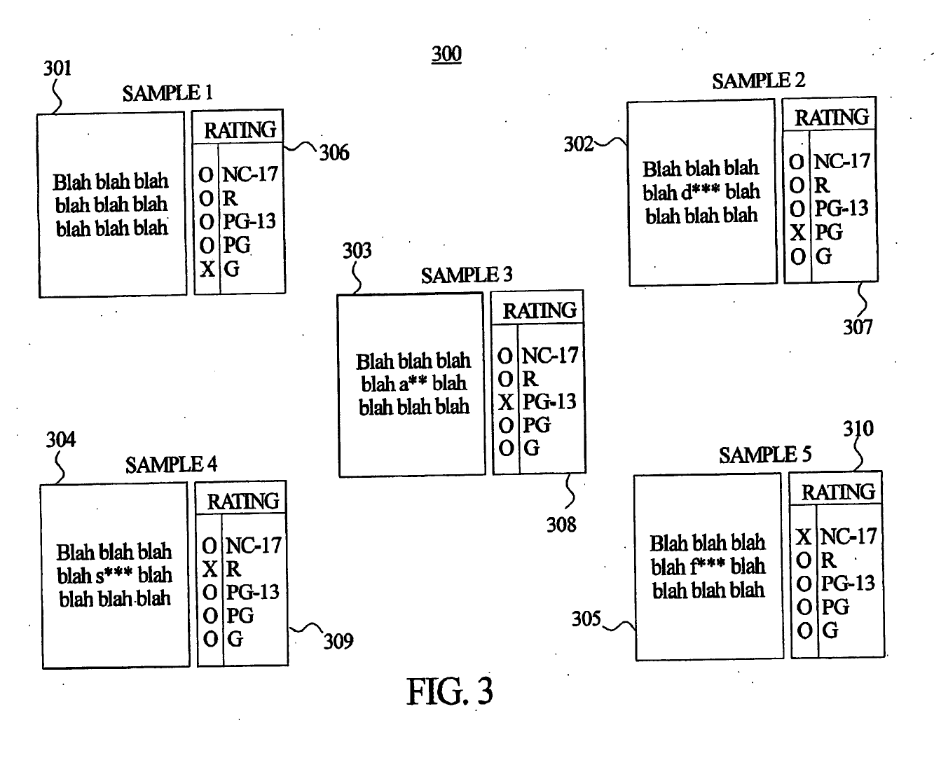

Referring to FIG. 3, a diagram 300 of exemplary rating samples and user rating assignments according to the embodiment of FIG. 2 is shown. In particular, FIG. 3 illustrates five exemplary rating samples 301 to 305 having assigned user ratings shown in blocks 306 to 310, respectively, which for purposes of example are shown as MPAA ratings. The five rating samples 301 to 305 and corresponding user rating assignments in blocks 306 to 310 may for example be generated during five iterations of steps 201 to 203 of FIG. 2. For purposes of example and explanation, each of the five rating samples 301 to 305 in FIG. 3 includes text data. Accordingly, rating samples 301 to 305 may for example represent pages of data received via a network such as the internet.

In FIG. 3, first sample 301 has an assigned user rating of G, as indicated in block 306. Second sample 302 has an assigned user rating of PG, as indicated in block 307. Third sample 303 has an assigned user rating of PG-13, as indicated in block 308. Fourth sample 304 has an assigned user rating of R, as indicated in block 309. Fifth sample 305 has an assigned user rating of NC-17, as indicated in block 310. Rating samples 301 to 305 and rating assignment blocks 306 to 310 may for example be displayed as part of an EPG. Of course, the assigned user ratings shown in FIG. 3 are merely examples and different users may assign different ratings to the same sample.

As previously indicated herein, a greater degree of rating limit personalization is achieved as more samples are rated by the user. Accordingly, in FIG. 2, the degree of rating limit personalization achieved is influenced by the number of times steps 201 to 203 are repeated. This concept is illustrated by the equation:
X*Y=N, where
N=the total number of samples rated by the user;
X the number of rating categories; and
Y=the number of samples rated in each rating category.

For example, if X equals 5 indicating 5 different rating categories (e.g., language, sexual content, violence, drugs, nudity), and Y equals 5 indicating that a user has rated 5 samples based on each of the 5 different rating categories, then N equals 25. Here, Y may be an important factor for establishing user preferences. For example, if a user assigns two different language ratings to two different samples having similar language content, then a third sample may be used as a tie-breaker. If, however, the third sample receives yet a different rating than the first two samples, then a fourth and fifth sample may be used as the tie-breaker. Accordingly, it is preferable that Y is an odd number greater than 2. In all cases, however, the greater the value of Y (and hence N), the greater the degree of rating limit personalization.

If the user decides at step 203 of FIG. 2 not to rate another sample, process flow advances to step 204 where processor 50 executes rating limits application 24 to generate one or more rating transition points for storage in rating limits database 26. Table 1 below illustrates exemplary rating transition points for the embodiment of FIGS. 2 and 3.

TABLE 1

| | | | First | | Second |
|---|---|---|---|---|---|
| | | First | Source | Second | Source |
| | User | Source | Transition | Source | Transition |
| Sample | Rating | Rating | Point | Rating | Point |
| 1 | G | 2 | 2 | 5 | 5 |
| 2 | PG | 5 | 2 | 7 | 5 |
| 3 | PG-13 | 8 | 5 | 8 | 7 |
| 4 | R | 9 | 8 | 15 | 8 |
| 5 | NC-17 | 12 | 9 | 16 | 15 |

According to the exemplary embodiment represented in Table 1, each of the samples rated by the user at step 202 (i.e., samples 301 to 305 of FIG. 3) also includes a rating assignment from two different sources. These sources may for example be different television broadcasters, internet databases, and/or other data distribution sources that provide a rating assignment to a rating sample. As indicated in Table 1, the rating transition points are generated based on the rating assignments from the two different sources, and there are different rating transition points associated with the two different sources.

According to the exemplary embodiment represented in Table 1, the rating transition points are generated to reflect a conservative approach to parental control. In particular, for a given source, the rating transition point corresponding to a given user rating is set equal to that source's rating assignment for one rating level below the given user rating. For example, with respect to the first source in Table 1, the rating transition point corresponding to a user rating of PG-13 is 5, which is equal to the first source's rating assignment for the user rating of PG. Similarly, and also with respect to the first source in Table 1, the rating transition point corresponding to a user rating of R is 8, which is equal to the first source's rating assignment for the user rating of PG-13. The aforementioned approach for generating rating transition points is reflected for all of the user ratings in Table 1, except the G rating where the rating transition points are simply set equal to the sources' rating assignments for the G rating.

Other approaches for generating rating transition points may also be used according to the present invention. For example, the rating transition point corresponding to a given user rating may be set equal to a source's rating assignment for the given user rating (as with the G rating in Table 1). As will discussed later herein, the rating transition points associated with a given source are used to determine whether data from that given source is output or blocked.

Next, at step 205, the user assigns a rating limit to each individual of the household, and processor 50 causes the assigned rating limits to be stored in rating limits database 26. According to an exemplary embodiment, the user assigns the rating limits at step 205 via input device 30 and an on-screen menu (e.g., EPG) on display 70. For example, using the MPM rating system, the youngest child in the household may be assigned a G rating, while an older child may be assigned a higher rating, such as PG or PG-13. Similarly, adults may also be assigned a rating limit, such as R or NC-17. Of course, different rating systems may also be used.

Then, at step 206, the assigned rating limits and the one or more rating transition points are retrieved from rating limits database 26 and used by processor 50 during operation of the apparatus to determine whether data is output or blocked. According to an exemplary embodiment, if the assigned rating limit for a particular individual is PG-13, that individual may access (e.g., view) all data (e.g., video, audio, text, etc.) from the first source having an assigned rating less than 5, which is the rating transition point for the first source and the PG-13 rating (see Table 1). Similarly, the individual may also access all data from the second source having an assigned rating less than 7, which is the rating transition point for the second source and the PG-13 rating (again see Table 1).

According to another exemplary embodiment, a “less than or equal to” standard may be used instead of the aforementioned “less than” standard to determine whether data is output or blocked. Accordingly, in the examples above, if the assigned rating limit for an individual is PG-13, that individual may access all data from the first source having an assigned rating less than or equal to 5, and may also access all data from the second source having an assigned rating less than or equal to 7.

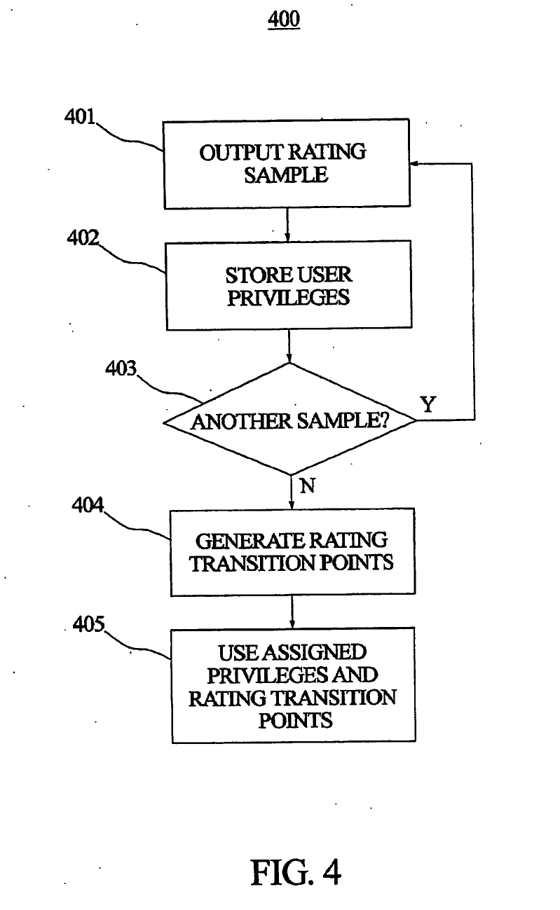

Turning now to FIG. 4, a flowchart 400 illustrating exemplary steps for carrying out another embodiment of the present invention is shown. For purposes of example and explanation, the steps of FIG. 4 will also be described with reference to the portion 100 of the apparatus shown in FIG. 1. Accordingly, the steps of FIG. 4 are merely exemplary and are not intended to limit the present invention in any manner.

At step 401, processor 50 executes rating limits application 24 and thereby causes a rating sample to be retrieved from rating samples database 22 and output for user rating. According to an exemplary embodiment, the rating sample comprises image data (e.g., video, still shot, text, etc.) and is output for display on display 70, but may also comprise audio data.

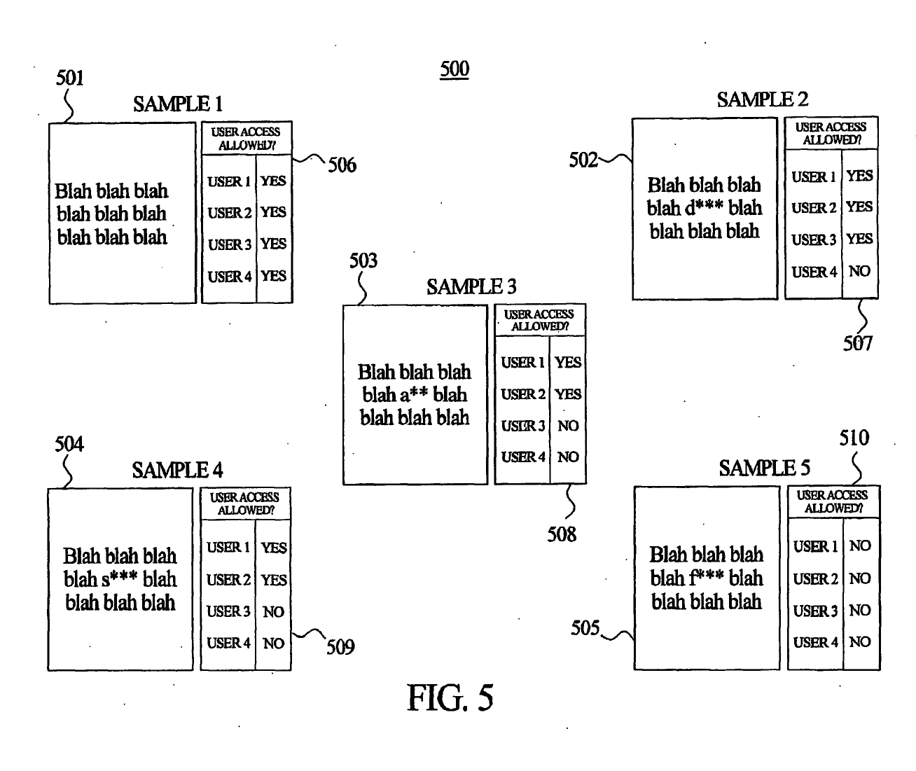

At step 402, the user assigns user privileges based on the output rating sample, and processor 50 causes data representative of the assigned privileges to be stored in rating limits database 26. According to an exemplary embodiment, the assigned user privileges indicate whether individuals within the household may access (e.g., view) data having a rating corresponding to the particular output sample. The user may for example assign the privileges at step 402 via input device 30 and an on-screen menu (e.g., EPG) on display 70. Further details regarding the assignment of user privileges will be provided later herein with reference to FIG. 5.

After the assigned user privileges are stored at step 402, process flow advances to step 403 where the user has the option to assign privileges based on another rating sample. In the event the user decides to assign privileges for another sample, process flow loops back to step 401 where processor 50 causes another rating sample to be retrieved from rating samples database 22 and output for user evaluation. In this manner, the user may evaluate many different rating samples and assign user privileges based on these evaluations. As previously discussed herein, a greater degree of rating limit personalization is achieved as more samples are evaluated by the user.

FIG. 5 is a diagram 500 illustrating exemplary rating samples and assigned user privileges according to the embodiment of FIG. 4. In particular, FIG. 5 illustrates five exemplary rating samples 501 to 505 having assigned user privileges shown in blocks 506 to 510, respectively. For purposes of example and explanation, rating samples 501 to 505 in FIG. 5 are the same as rating samples 301 to 305 in FIG. 3. Accordingly, each of the five rating samples 501 to 505 in FIG. 5 includes text data, and may for example represent pages of data received via a network such as the internet. The five rating samples 501 to 505 and corresponding user privilege blocks 506 to 510 may for example be generated during five iterations of steps 401 to 403 of FIG. 4.

In FIG. 5, first sample 501 has assigned user privileges shown in block 506 indicating that all users (i.e., users 1 to 4) may access data having a rating corresponding to sample 501. Second sample 502 has assigned user privileges shown in block 507 indicating that all users except user 4 may access data having a rating corresponding to sample 502. Third sample 503 has assigned user privileges shown in block 508 indicating that only users 1 and 2 may access data having a rating corresponding to sample 503. Fourth sample 504 has assigned user privileges shown in block 509 indicating that only users 1 and 2 may access data having a rating corresponding to sample 504. Fifth sample 505 has assigned user privileges shown in block 510 indicating that none of the users may access data having a rating corresponding to sample 505. Rating samples 501 to 505 and user privilege blocks 506 to 510 may for example be displayed as part of an EPG. Of course, the assigned user privileges shown in FIG. 5 are merely examples.

If the user decides at step 403 of FIG. 4 not to assign user privileges for another sample, process flow advances to step 404 where processor 50 executes rating limits application 24 to generate one or more rating transition points for storage in rating limits database 26. Table 2 below illustrates exemplary rating transition points for the embodiment of FIGS. 4 and 5.

TABLE 2

| | | | First | | Second |
|---|---|---|---|---|---|
| | | First | Source | Second | Source |
| | User | Source | Transition | Source | Transition |
| Sample | Access | Rating | Point | Rating | Point |
| 1 | 1, 2, 3, 4 | 2 | 2 | 5 | 5 |
| 2 | 1, 2, 3 | 5 | 2 | 7 | 5 |
| 3 | 1, 2 | 8 | 5 | 8 | 7 |
| 4 | 1, 2 | 9 | 8 | 15 | 8 |
| 5 | No one | 12 | 9 | 16 | 15 |

As indicated in Table 2, each of the samples evaluated by the user at step 402 (i.e., samples 501 to 505 of FIG. 5) also includes a rating assignment from two different sources, such as different television broadcasters, internet databases, and/or other data distribution sources that provide a rating assignment to a rating sample. Accordingly, the embodiment represented in Table 2 is the same as the embodiment represented in Table 1 in that the rating transition points are generated based on the rating assignments from the two different sources, and there are different rating transition points associated with the two different sources. More specifically, the rating transition points in Table 2 are the same as the rating transition points in Table 1, and they may be generated in the same manner. Therefore, for clarity of description, the details regarding the generation of rating transition points at step 404 will not be repeated.

At step 405, the assigned user privileges and the one or more rating transition points are retrieved from rating limits database 26 and used by processor 50 during operation of the apparatus to determine whether data is output or blocked. According to an exemplary embodiment, a user may access all data from a given source having an assigned rating that is less than the transition point corresponding to the user's assigned privileges. More specifically, in Table 2, user 4 may access all data from the first source having an assigned rating less than 2, and all data from the second source having an assigned rating less than 5. User 3 may access all data from the first source having an assigned rating less than 5, and all data from the second source having an assigned rating less than 7. Similarly, users 1 and 2 may access all data from the first source having an assigned rating less than 9, and all data from the second source having an assigned rating less than 15.

According to another exemplary embodiment, a “less than or equal to” standard may be used instead of the aforementioned “less than” standard to determine whether data is output or blocked. Accordingly, with this embodiment, user 4 may access all data from the first source having an assigned rating less than or equal to 2, and all data from the second source having an assigned rating less than or equal to 5. User 3 may access all data from the first source having an assigned rating less than or equal to 5, and all data from the second source having an assigned rating less than or equal to 7. Similarly, users 1 and 2 may access all data from the first source having an assigned rating less than or equal to 9, and all data from the second source having an assigned rating less than or equal to 15.

The present invention is particularly applicable to various apparatuses having a parental control system, either with or without a display device. Accordingly, the invention described herein may be implemented in various types of systems or apparatuses including, but not limited to, television sets, computers or monitors that include a display device, and systems or apparatuses such as set-top boxes, computers, video cassette recorders (VCRs), digital versatile disk (DVD) players, video game boxes, personal video recorders (PVRs) or other apparatuses that may not include a display device. Moreover, the present invention may be implemented in hardware and/or software, where for example a software implementation may be part of the operating system, installed as a separate program, and/or distributed.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method for personalizing rating limits in a parental control system, comprising:
enabling reproduction of a rating sample having a first rating from a first source;
detecting a user input indicating the acceptability of the rating sample;
generating a first transition point based on the user input and the first rating; and
using the first transition point to determine whether data from the first source is output or blocked.

2. The method of claim 1, wherein the rating sample further includes a second rating from a second source, and further comprised of:
generating a second transition point based on the user input and the second rating; and
using the second transition point to determine whether data from the second source is output or blocked.

3. The method of claim 1, wherein the user input indicates an MPAA rating.

4. The method of claim 1, wherein the user input indicates a TV Parental Guidelines rating.

5. The method of claim 1, wherein the user input indicates the acceptability of the rating sample for one or more individuals.

6. The method of claim 1, wherein the ratings sample comprises at least one of video data, audio data and text data.

7. An apparatus, comprising:
interface means for detecting a user input indicating the acceptability of a rating sample having a first rating from a first source; and
control means for generating a first transition point based on the user input and the first rating, and for using the first transition point to determine whether data from the first source is output or blocked.

8. The apparatus of claim 7, wherein the rating sample further includes a second rating from a second source, and the control means generates a second transition point based on the user input and the second rating and uses the second transition point to determine whether data from the second source is output or blocked.

9. The apparatus of claim 7, wherein the user input indicates an MPAA rating.

10. The apparatus of claim 7, wherein the user input indicates a TV Parental Guidelines rating.

11. The apparatus of claim 7, wherein the user input indicates the acceptability of the rating sample for one or more individuals.

12. The apparatus of claim 7, wherein the ratings sample comprises at least one of video data, audio data and text data.

13. A television signal receiver, comprising:
an interface operative to detect a user input indicating the acceptability of a rating sample having a first rating from a first source; and
a processor operative to generate a first transition point based on the user input and the first rating, and to use the first transition point to determine whether data from the first source is output or blocked.

14. The television signal receiver of claim 13, wherein the rating sample further includes a second rating from a second source, and the processor is operative to generate a second transition point based on the user input and the second rating and to use the second transition point to determine whether data from the second source is output or blocked.

15. The television signal receiver of claim 13, wherein the user input indicates an MPAA rating.

16. The television signal receiver of claim 13, wherein the user input indicates a TV Parental Guidelines rating.

17. The television signal receiver of claim 13, wherein the user input indicates the acceptability of the rating sample for one or more individuals.

18. The television signal receiver of claim 13, wherein the ratings sample comprises at least one of video data, audio data and text data.
